(19) United States
(12) Patent Application Publication
(10) Pub. No.: US 2016/0337306 A1
(43) Pub. Date: Nov. 17, 2016

(54) Athlete-Centric Method for Organizing Sporting Events

(71) Applicant: John Black, Bellevue, WA (US)

(72) Inventor: John Black, Bellevue, WA (US)

(21) Appl. No.: 15/138,026

(22) Filed: Apr. 25, 2016

Related U.S. Application Data
(60) Provisional application No. 62/162,455, filed on May 15, 2015.

(51) Int. Cl. H04L 12/58; A63F 13/816; H04L 29/08

(52) U.S. Cl. CPC H04L 51/32; H04L 67/12; A63F 13/816

(57) ABSTRACT

Aspects of the present invention relate to a system for enabling athletes to challenge other athletes to competitive events and organize these athletic events with venue managers, promoters, media representatives, fans and other parties. Some aspects relate to automated messaging or publication to fans and other interested parties. Some aspects relate to enabling athletes to negotiate royalty agreements for their performances at the organized events.

### CROSS-RELATED APPLICATIONS

This application claims benefit to U.S. Provisional Patent Application No. 62/162,455 which was filed on May 15, 2015.

### BACKGROUND OF THE INVENTION

1. Field of the Invention

The present invention relates to methods and apparatus for athlete and athletic event organization and promotion.

2. Background and Related Art

Currently, athletic events are arranged through a complex relationship of multiple parties and representatives communicating over different media in a manner that often excludes the athletes from the organization or negotiating processes. Often, athletes cannot organize an event themselves and require expensive third parties to arrange events.

### BRIEF SUMMARY OF THE INVENTION

A method and apparatus are provided for connecting athletes, fans, promoters, trainers and other parties in a manner that allows organizing, scheduling, publishing and advertising athletic events. Some embodiments provide for a challenge system wherein one athlete or team can challenge another athlete or team to a competition and, if accepted, the system can automatically notify fans, venue managers, media reps, trainers and other parties. When all event details are accepted by the responsible parties, the fans can be notified of the scheduled event. Some embodiments further comprise communication methods for athletes to communicate with and negotiate with trainers, managers, promoters, venue managers, vendors, experts, media reps and fans. Some embodiments may allow fans to consume content related to athletic performances.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows an exemplary general-purpose computer system;

FIG. 2 shows a representative networked system configuration related to embodiments of the present invention;

FIG. 3 is an organizational chart showing parties connected with an embodiment of the present invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

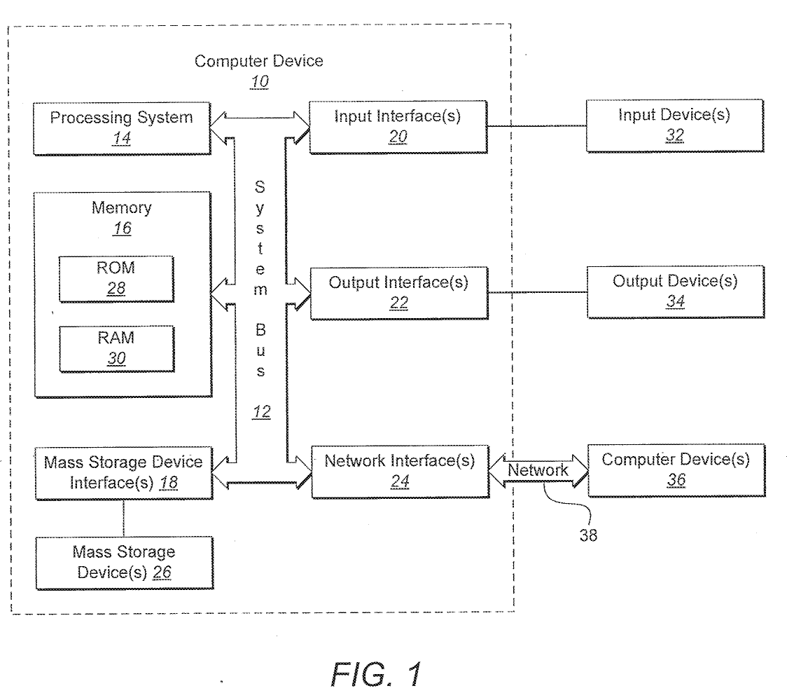

FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), standalone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook or laptop computer, a netbook, a personal digital assistant (“PDA”) or other hand-held device, a smart phone, a tablet computer, a workstation, a minicomputer, a mainframe, a supercomputer, a multi-processor system, a network computer, a processor-based consumer electronic device, a computer device integrated into another device or vehicle, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard, touchpad, dedicated buttons, mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

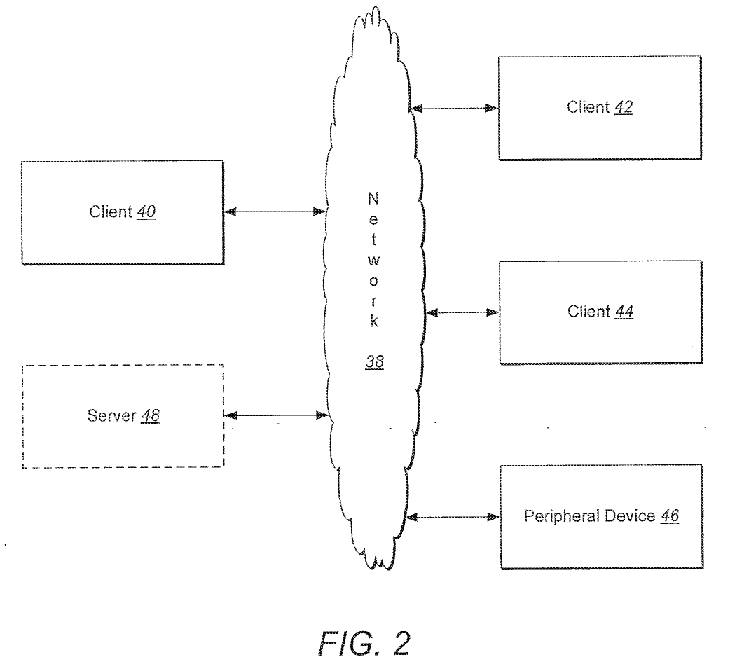

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Similarly, embodiments of the invention embrace cloud-based architectures where one or more computer functions are performed by remote computer systems and devices at the request of a local computer device. Thus, returning to FIG. 2, the client 40 may be a computer device having a limited set of hardware and/or software resources. Because the client 40 is connected to the network 38, it may be able to access hardware and/or software resources provided across the network 38 by other computer devices and resources, such as client 42, client 44, server 48, or any other resources. The client 40 may access these resources through an access program, such as a web browser, and the results of any computer functions or resources may be delivered through the access program to the user of the client 40. In such configurations, the client 40 may be any type of computer device or electronic device discussed above or known to the world of cloud computing, including traditional desktop and laptop computers, smart phones and other smart devices, tablet computers, or any other device able to provide access to remote computing resources through an access program such as a browser.

To minimize the need to download and/or install programs on users' computing devices, embodiments of the invention utilize existing web browser technology. Many browser programs currently exist or are under development, and it would be impossible to name all such browser programs, but examples of such programs include Microsoft's Internet Explorer, Mozilla Firefox, Google Chrome, Apple Safari, Opera Software's Opera browser, as well as myriad browsers specifically configured for specific devices, such as Internet-connected smart phones and the like. The exact display of each browser can vary from browser to browser and most are moderately to highly configurable so as to vary the exact display,

Many currently-available browser programs permit the installation of additional features, such as through what are commonly known as “browser extensions.” Browser extensions are becoming more and more common in today's browser programs, and have become one of if not the standard for extending the functionality of the browser programs. For browsers that do not currently support browser extensions, other mechanisms and installed programs are often available to provide similar functionality.

Embodiments of the invention may utilize a browser extension or similar format to provide functions in accordance with embodiments of the invention. The use and installation of a browser extension is typically significantly less involved and less computer-intensive than the use and installation of a stand-alone program. In many instances, the installation of the browser extension occurs essentially without the computer's operating system being made aware of any additional installation. Instead, the browser program itself handles the browser extension and any demands made by the browser extension.

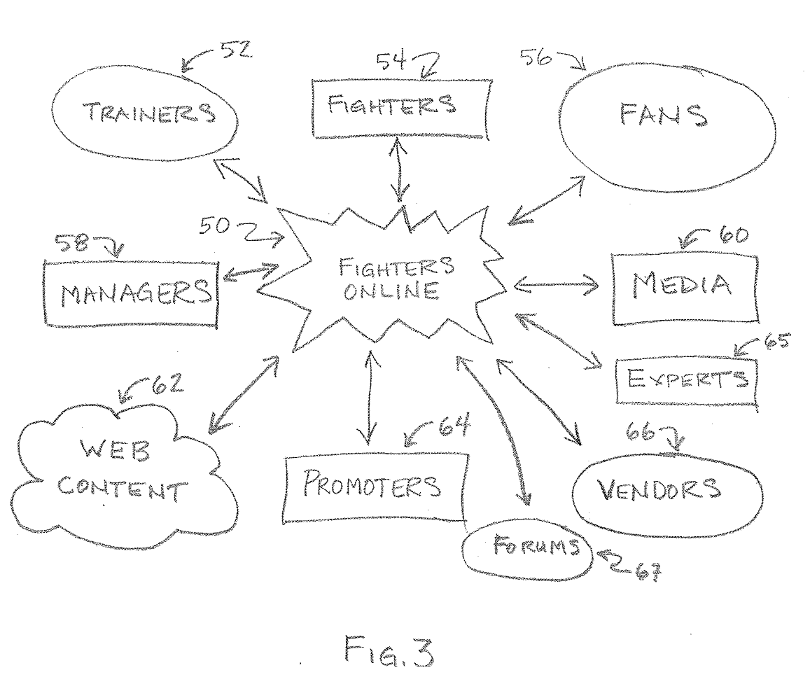

Exemplary embodiments of the present invention may be described with reference to FIG. 3, which is a diagram showing exemplary participants in the systems and methods of the present invention. The exemplary embodiments illustrated in FIG. 3 involve fighters, such as boxers, mixed martial arts (MMA) fighters, wrestlers, martial arts fighters such as tae kwon do, karate, and judo, and other fighters of various disciplines. However, other embodiments may comprise athletes of other sports and disciplines who may wish to develop themselves, their sports and their fanbase.

In these exemplary embodiments, a fighters online (FO) platform 50 may be employed as a connective hub to provide structured communication between athletes such as fighters 54, their fans 56 and other parties who bring them together for mutual benefit. The FO platform 50 may comprise a website written in a markup language such as hypertext markup language (HTML), extensible hypertext markup language (XHTML), extensible markup language (XML) or others. These particular embodiments may then be interpreted by a browser in a typical operation.

Other embodiments or implementations may comprise stand-alone computer programs or applications that may be run directly on general purpose computers such as desktop computers, tablet computers, smart phones and other computing devices. Other embodiments may comprise combinations of stand-alone code and browser-interpreted code to implement aspects of the present invention. Still other embodiments may be implemented as special purpose computing devices with dedicated logic circuits for accomplishing the methods of the present invention.

The FO platform 50 comprises a multiplicity of links and connections to connect athletes, such as fighters 54, with myriad other parties who are interested in the organization, promotion, training and consumption of athletic performances. Some of these relationships may be described herein based on their interaction with the FO platform 50.

One interaction is the relationship between the athlete or fighter 54 and the FO platform 50. This relationship is typically carried out as the fighter 54 accesses a website hosting the FO platform 50. However, this interaction may also be accomplished by non-browser-based methods with menus and other user input techniques. In an exemplary, browser-based embodiment, the fighter 54 may access a website with the FO platform 50. The FO platform 50 may comprise a web page with an interface for starting a new account, logging into an existing account and other options. The FO platform may offer a variety of different account types based on the user type. A fighter 54 may start a fighter or athlete account that enables the fighter 54 to interact with other parties through the FO platform 50.

A fighter account may comprise methods for receiving fighter input for system usage. This may comprise text input boxes, question and answer selections, radio buttons with descriptions and various user input (UI) schemes known in the art. Using these methods, a fighter 54 may input the fighter's personal information such as name, age, weight, contact info, fighting styles and any other personal information. A fighter 54 may also input performance data, such as fights fought, fights won, current fighting category or weight class and other information relevant to a fighter's performance or desired performance level.

It should be noted that any item of a fighter's data can be tagged with different levels of confidentiality so that that item can only be accessed by specified individuals. Some sensitive data may only be accessible to the fighter 54 and the FO platform 50. Some information may only be accessible to the fighter 54 and his/her trainer 52. Likewise, some contract information may only be accessible to a promoter 64 or a manager 58. This confidential information may be stored on a secure server as a part of the overall web content 62.

A fighter 54 may also input their current training status, which may comprise whether or not they currently have a trainer, whether they are looking for a trainer, the current training regimen, desired changes in regimen or goals and other training-related information. This information may be used, when selected by the fighter 54, to solicit a trainer. The FO platform 50 may make this information accessible to qualified member trainers who may then elect to place an offer to train via the FO platform 50.

Similarly, a fighter 54 may input management information related to whether the fighter 54 has a manager, needs a manager, has a specific management budget or wants to use a default management program through the FO platform 50.

Through some embodiments, a fighter/athlete 54 may input or arrange to have input consumable athletic content, such as fight videos, interviews, performance statistics, still imagery of athletic performances, quotations, digital autographs and other online-accessible content. A fighter/athlete 54 may also negotiate agreements with vendors 66, media 60 or other parties to make endorsements or other agreements to sell digital or physical content featuring the fighter/athlete 54. This online, digital and physical content may be accessible to fans 56 through an online retail outlet portion of the FO platform 50.

Once multiple athletes 54 have registered on the FO platform 50, a first fighter/athlete 54 may challenge a second fighter/athlete 54 to a fight or athletic competition. To achieve this, a first fighter may access the FO platform 50 and select the second fighter's page or a fighter-specific page on the platform website where the first fighter will have the option to challenge the second fighter to a competition. When this challenge is issued, the FO platform 50 may automatically send messages to interested parties. For example, the challenged second fighter would receive a challenge message inviting him/her to a match or competition. Additionally, other associated parties may also receive messages. For example, the challenged fighter's trainer 52, manager 58, promoter 64, fans 56, lawyer 65 and a forum/venue manager 67 if selected.

If the challenged fighter accepts the challenge, a similar series of messages may be sent to parties associated with the challenger and/or acceptor. In some embodiments, an accepted challenge may also trigger automated messaging and/or advertising sent to the fans 56 of both fighters/athletes involved. Similarly, athletes may be organized with team accounts and a first team may challenge a second team to a competition. In this scenario, messaging may be sent to team personnel, agents and other parties as well as team fans and individual athlete fans.

Additionally, when a forum or venue is selected by one or more of the involved athletes, either during the challenge or the acceptance, an automated message may be sent to the venue manager 67 to schedule the venue/forum Likewise, when a forum manager 67 accepts an invitation to schedule an event, automated messaging may notify any interested parties in the system, including fans 56, that the event has been officially scheduled. A forum or venue may comprise a physical location with equipment or a building to accommodate the athletic event and may or may not comprise seating for an audience. A venue may comprise a fighting ring with equipment to accommodate television cameras and audio and video equipment for broadcasting or transmitting event video feeds to the FO platform 50 from which fans can view the video content. In some embodiments, a venue may also comprise seating for a live audience that may be booked through the FO platform by fans 56. This booking may occur in response to fan messaging that occurs automatically when an event is announced by challenge acceptance or otherwise.

In some embodiments, the FO platform 50 may comprise a fighter interface that allows a fighter to negotiate media coverage with a media entity 60. The FO platform 50 may comprise standard contracts with variable contract terms, such as licensing royalties, based on a fighter's ranking or performance score in relation to performances or fights arranged through the FO platform 50 or otherwise. Media entity 60 negotiation may be initiated by automated messaging triggered by a fighter's performance score reaching a threshold level selected by the media entity 60 or based on some other performance metric. A media entity 60 may also browse fighter statistics via the FO platform 50 and manually select a fighter for negotiation.

In some embodiments, the FO platform 50 may comprise a fighter interface that allows a fighter to negotiate with experts 65 such as doctors, physical therapists and lawyers specializing in business, licensing, intellectual property and other areas. These experts may have standard agreements or services available through the FO platform 50 and may offer agreement modification or other services in addition to standard agreements.

In some embodiments, the FO platform 50 may comprise a fighter interface that allows a fighter to communicate with vendors 66 in relation to endorsement, purchasing, sales, service and other communication. These vendors 66 may comprise vendors who sell products endorsed by a fighter/athlete 54, and communication may comprise negotiation of a licensing agreement. Vendors 66 may also comprise vendors who supply goods and/or services during an athletic event and communication with them may comprise negotiating provisions for an event. Vendors 66 may also comprise vendors who sell products consumed by a fighter/athlete 54, such as athletic equipment, clothing, uniforms, shoes, dietary supplements and other products and communication with them may comprise negotiation of purchase agreements, barter agreements, endorsement-in-exchange or other agreement details.

In some embodiments, the FO platform 50 may comprise a fighter interface that allows a fighter to communicate with forum or venue managers 67. This interface may comprise methods for scheduling a fight or event, requesting an event and/or provisionally requesting an event based on a challenge acceptance as well as other communications. This interface may also automatically notify venue managers 67 when an event has been scheduled and/or a challenge has been accepted and provide a method for venue managers 67 to indicate the availability of their venue for a specified event. This communication may be sent directly to the fighter/athlete 54 and/or to a manager 58, promoter 64, fans 56, media 60 or any other party or parties that may be involved.

In some embodiments, the FO platform 50 may comprise a fighter interface that allows a fighter to communicate with a promoter 64. This fighter/promoter interface may comprise methods for a fighter 54 to propose an event and communicate the event to potential promoters who may want to provide prizes or other compensation to the fighters 54 as well as manage the venue 67, media 60 and advertise to the fans 56. In some embodiments, a promoter may be automatically notified when a challenge is made or accepted.

In some embodiments, the FO platform 50 may comprise a fighter interface that allows a fighter to upload personal content to cloud or web storage 62 or some form of media storage accessible to parties via the FO platform 50. This content may comprise fight video, athletic event video, promotional video, interview video, still images of an athlete during performance or outside performance, athletic statistics, and other digital media that may be consumed by fans 56, used by other parties in promotion of events or for other uses.

In some embodiments, the FO platform 50 may comprise a fan interface that allows a fan to access fighter/athlete-specific content, event-specific content and other content via the FO platform 50. In some embodiments, a fan 56 may access video, still image, text and audio related to a specific athlete or athletes and view the schedule of the athletes' scheduled events. This fan access may require payment on a content-specific basis, by subscription or by some other basis. Payments can be received via the FO platform 50 by credit card, debit card, prepaid card redemption or by other methods known in the art.

The fan interface may further comprise a method for a fan 56 to subscribe to messaging related to a specific athlete, event, venue or other performance parameter, such as when an athlete reaches a designated performance metric. By this method, a fan may receive automated messaging related to a fighter, upcoming event, challenge, promotion or other information.

The fan interface may further comprise a method for a fan 56 to purchase products from vendors 66 via the FO platform 50. Typically these products will be related to or endorsed by an athlete or event.

In some embodiments, a fan 56 may upload web content to the FO platform 50 web content storage resource 62.

In some embodiments, the FO platform 50 may comprise a media interface that allows a media representative 60 to subscribe to messaging related to a specific athlete, event, venue or other performance parameter, such as when an athlete reaches a designated performance metric. A media representative 60 may also provide messaging content related to athletes, such as when a news broadcast will mention an athlete, when information related to an event will be broadcast and other media related information. This messaging can be forwarded to fans 56 and other parties through the FO platform 50. In some embodiments, the media interface may provide for a method of negotiating agreements between media reps 60 and athletes 54, promoters 64 and other parties. In some embodiments, standard agreements may be automatically offered by media reps 60, promoters 64 or other parties when a fighter 54 achieves a specific performance metric. A media rep 60 may also upload web content to the FO platform 50 web content storage resource 62.

In some embodiments, the FO platform 50 may comprise an expert interface that allows an expert 65 to provide goods and/or services to a fighter/athlete 54 or another party. Experts 65 may comprise, doctors, physical therapists, lawyers, publicity agents and others. Services offered by experts 65 may comprise medical evaluations, therapy sessions, licensing agreements, publicity contracts and other services. Through this interface, an expert may subscribe to messaging related to a specific athlete, event or other occurrence. An expert may also contact athletes and other parties in relation to the services they offer. An expert may also offer standard packages for services at specified rates. An expert 65 may also upload web content to the FO platform 50 web content storage resource 62.

In some embodiments, the FO platform 50 may comprise a vendor interface that allows vendors 66 to offer endorsement agreements to fighter/athletes 54, offer products for sale to fighter/athletes 54, offer products to fans 56, upload web content 62 and other perform other functions. In an exemplary embodiment, a vendor 66 with an endorsement agreement from an athlete/fighter 54 may upload consumable web content 62 via the FO platform 50 for consumption by fans 56 via the FO platform 50, for example, a vendor 66 may create artistic, stylized still imagery (e.g., screen saver or background image for computer or phone) of an athlete and sell the imagery to fans 56 via the FO platform 50. In another exemplary embodiment, a sports equipment vendor 66 may have an endorsement agreement with a fighter/athlete 54 and offer their sports equipment for sale to fans via the FO platform 50.

In some embodiments, the FO platform 50 may comprise a forum/venue interface that allows a forum/venue manager 67 to communicate with fighters/athletes 54, promoters 64, media 60, vendors 66 and other parties to accomplish scheduling, informing and other tasks as well as negotiate agreements. In an exemplary embodiment, a venue manager 67 may be informed of an accepted challenge between two fighters who have indicated a preference for a specific venue and the venue manager 67 may respond with a message indicating availability and pricing structure. In another exemplary embodiment, a venue manager 67 may post venue availability with a calendar format indicating pricing for available dates and fighters 54, promoters 64, managers 58 or other parties may select a desired date to schedule an event. A venue manager 67 may also upload web content to the FO platform 50 web content storage resource 62.

In some embodiments, the FO platform 50 may comprise a promoter interface that allows a promoter 64 to communicate with fighters/athletes 54 and other parties. Using the FO platform 50, a promoter 64 may contact a fighter/athlete 54 and negotiate a promotion agreement. A promoter 64 may also contact fans 56 via FO platform 50 messaging to announce an event or other messaging. A promoter 64 may also contact a media rep 60 relative to an event or athlete 54 via the FO platform 50. In fact, in some embodiments, a promoter 64 may contact any party associated with the FO platform 50 and may also upload web content 62.

In some embodiments, the FO platform 50 may comprise a web content 62 storage resource for storing web content such as video imagery, still imagery, audio files, text information, computer-readable instructions and other data. This resource may comprise a server for serving up web content 62 to parties connected to the FO platform 50. In an exemplary embodiment, fans 56 may subscribe to access digital web content stored on this resource via the FO platform 50. In an exemplary embodiment, a fighter 54 may access standardized contracts stored on this resource 62 to help accomplish contract negotiations.

In some embodiments, the FO platform 50 may comprise a manager interface that allows a manager 58 to communicate with a fighter/athlete 54 or other parties. Using this interface, a manager 58 may inform a fighter/athlete 54 of upcoming events, compensation schemes and other information. In an exemplary embodiments, a manager may access a fighter/athlete 54 calendar to schedule events and/or become informed of scheduled events.

In some embodiments, the FO platform 50 may comprise a trainer interface that allows a trainer 52 to communicate with a fighter/athlete 54, a manager 58 and other parties. Using this interface, a trainer 52 may inform a fighter/athlete 54 of his/her training schedule via a calendar system, messaging system or otherwise. A trainer 52 may also be informed of changes in the fighter/athlete's schedule via this interface through automatic messaging or otherwise. In an exemplary embodiment, a trainer 52 may schedule workouts, matches, physical therapy, doctor's exams, and other activities for a fighter/athlete 54 and the system will automatically inform the fighter/athlete 54 via a calendar or other messaging system.

In some embodiments, the FO platform 50 may also comprise a demographics/analysis (D/A) module 69 for analyzing details of a fighter/athlete's locations, performances, venues, endorsements, career, hobbies, fan base, fan demographics, potential challengers and other data. In some embodiments, the D/A module 69 may analyze a fighter/athlete's data to identify a fan base and the opinion's of the fans relative to potential challengers. In some embodiments, fan input may be solicited and analyzed to determine fan interest in specific matchups, venues or other events. In some embodiments, a fighter/athlete's zip code may be used to identify a fan base location. In some embodiments, a fighter/athlete's overall fan strength may be determined based on past performance quality and location, endorsement record, schools attended and other data. This fan strength value may then be used in manual or automated processes to determine specific details of royalty agreements, endorsement agreements, media agreements and other negotiations.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A tangible, non-transitory, computer-readable medium comprising instructions instructing a processor in an athletic management system to:
store a challenge request comprising a challenging athlete identification and a challenged athlete identification;
send said challenge request to said challenged athlete via an electronic messaging system;
provide a response mechanism for said challenged athlete to accept said challenge request;
send a challenge accepted message to said challenging athlete when said challenge request is accepted; and
publish an athletic event announcement to said challenging athlete's fans and said challenged athlete's fans when said challenge request is accepted.

2. The medium of claim 1 wherein said instructions further comprise instructions for sending a challenge accepted message to the challenging athlete's trainer and the challenged athlete's trainer.

3. The medium of claim 1 wherein said instructions further comprise instructions for sending a challenge accepted message to a promoter.

4. The medium of claim 1 wherein said instructions further comprise instructions for sending a challenge accepted message to a venue manager.

5. The medium of claim 1 wherein said instruction further comprise instructions for sending a challenge accepted message to a media representative.

6. A method for automated athletic event organization and publication, said method comprising:
storing a challenge request comprising a challenging athlete identification and a challenged athlete identification;
sending said challenge request to said challenged athlete via an electronic messaging system;
providing a response mechanism for said challenged athlete to accept said challenge request;
sending a challenge accepted message to said challenging athlete when said challenge request is accepted; and
publishing an athletic event announcement to said challenging athlete's fans and said challenged athlete's fans when said challenge request is accepted.

7. An apparatus for automated athletic event organization and publication, said apparatus comprising:
a data storage for storing first fan contact data for a first athlete and second fan contact data for a second athlete;
an athlete interface for receiving and delivering challenge requests and challenge acceptance between athletes; and
a publishing module for publishing an athletic event announcement to said first athlete's fans and said second athlete's fans when said first athlete issued a challenge to said second athlete via said athlete interface and said second athlete has accepted said challenge via said athlete interface.

8. The apparatus of claim 7 wherein said publishing module further sends a message to said first athlete's trainer when said first athlete has issued a challenge to said second athlete via said athlete interface and said second athlete has accepted said challenge via said athlete interface.

9. The apparatus of claim 7 wherein said publishing module further sends a message to a promoter when said first athlete has issued a challenge to said second athlete via said athlete interface and said second athlete has accepted said challenge via said athlete interface.

10. The apparatus of claim 7 wherein said publishing module further sends a message to a designated venue manager when said first athlete has issued a challenge to said second athlete via said athlete interface and said second athlete has accepted said challenge via said athlete interface.

11. The apparatus of claim 7 wherein said publishing module further sends a message to a media representative when said first athlete has issued a challenge to said second athlete via said athlete interface and said second athlete has accepted said challenge via said athlete interface.
